(19) United States
(12) Patent Application Publication
(10) Pub. No.: US 2003/0129759 A1
(43) Pub. Date: Jul. 10, 2003

(54) Stable radiochromic dosimetry film and process

(76) Inventors: David Fairhurst Lewis, Monroe, CT (US); Hsiao-Yi Shih, Whippany, NJ (US); Janette Anyumba, Wayne, NJ (US)

Correspondence Address: REED SMITH LLP, 599 Lexington Avenue, New York, NY, 10022-7650, US

(21) Appl. No.: 10/229,489

(22) Filed: Aug. 28, 2002

Related U.S. Application Data
(60) Provisional application No. 60/315,865, filed on Aug. 28, 2001.

(51) Int. Cl. G01N 31/22

(52) U.S. Cl. 436/58; 422/56; 427/2.13

(57) ABSTRACT

A film media which is sensitive to low-energy x-rays which is suitable for use for measuring exposures within the range from about 200 to 1500 rads which is the range likely to cause patient skin injury. Moreover, the film product of the present invention can be made in large sheets. Accordingly, it is suitable for use during surgical procedures and particularly for full body exposure and in those cases when the location of the point of maximum exposure is not necessarily known. The Inventive film media is composed of a first support layer of a polymeric film which is permeable to low energy x-rays and a second layer thereon of a composition comprising a microcrystalline dispersion of a substantially crystalline image receptive polyacetylenic compound, and a compound that selectively absorbs incident low energy photon radiation.

### CROSS REFERENCE TO RELATED APPLICATIONS

This application corresponds to U.S. Provisional Patent Application Serial No. 60/315,865, filed on Aug. 28, 2001. the complete disclosure of which is hereby incorporated by reference.

### BACKGROUND OF THE INVENTION

1. Field of the Invention

This invention relates to a film for the low dose measurement of low energy photons. More specifically, it relates to a film for measurement of patient skin exposure during fluoroscopically guided interventional surgery procedures.

2. Background

In September, 1994, The Federal Drug Administration of the United States has issued a Public Health Advisory entitled “Avoidance of Serious Skin Injuries to Patients During Fluoroscopically-Guided Procedures.” One of the recommendations of the Advisory is that a record of the exposure of the patient be generated and maintained in the patient's medical file. The Federal Drug Administration recognized that the actual measurement of patient exposure presents difficulties because the x-ray beam is normally not focused on a single location of the patient during a procedure. Rather, the beam is moved about by the surgeon in order to follow the location of a surgical tool located at the end of a catheter which is within the patient's body.

Consequently, the use of spot dosimeters, such as, a photodiode, a metal oxide-silicon semiconductor field effect transistor (MOSFET) dosimeter, or a thermoluminescent dosimeter (TLD) is inappropriate because all the areas on the patient's skin that will be exposed to radiation and the location of maximum exposure cannot be known beforehand. Moreover, it is inconvenient and costly to use multiple spot dosimeters on a single patient during surgery.

A dose-area product meter can be used to measure total patient exposure. However, because the x-ray beam is not fixed, one cannot tell what the distribution of the total dose of exposure is over the patient's skin.

Another measurement technique uses x-ray film. However, the conventional silver halide based x-ray films are much too sensitive and saturate at exposure doses of 50 rads or less. Such an exposure is too low to be useful to indicate whether exposure likely to cause skin injury has occurred. The onset of skin injury occurs at a dose of about 200 rads.

Accordingly, a product is required which allows for the measuring of x-ray exposures of patients at levels which can normally cause patient injury, for example, 200 to 1500 rads and which would allow full body exposure during operative procedures.

### SUMMARY OF THE INVENTION

We have discovered a film media which is sensitive to low-energy x-rays which is suitable for use for measuring exposures within the range from about 200 to 1500 rads which is the range likely to cause patient skin injury. Moreover, the film product of the present invention can be made in large sheets. Accordingly, it is suitable for use during surgical procedures and particularly for full body exposure and in those cases when the location of the point of maximum exposure is not necessarily known.

Furthermore, the film of the present invention provides a radiation sensitive media that is particularly sensitive to low-energy x-rays typically seen in diagnostic radiography, for example, from about 20 keV-120 keV.

An additional advantage of the present invention is that in one embodiment, the active layer of the media can be directly between two substrates that protect the active layer from physical damage. The direct bonding avoids the need for glues or adhesive materials to effect the lamination of the active layer between the substrates.

In addition, the present invention provides a film media that is less sensitive than heretofore known film media to exposure to visible light and also possesses excellent shelf life stability. The shelf life stability can be enhanced by the inventive embodiments wherein specific additives are used to diminish the visible light sensitivity and decrease the dark reaction of the film. It is noticed that the dark reaction is a process wherein the optical absorbency of the film increases with time due to polymerization of the active component in the film. Such polymerization changes the shelf life of the film.

More particularly, we have discovered a film media which is sensitive to low energy x-rays which is composed of a first support layer of a polymeric film which is permeable to low energy x-rays and a second layer thereon of a composition comprising a microcrystalline dispersion of a substantially crystalline image receptive polyacetylenic compound, and a compound that selectively absorbs incident low energy photon radiation.

### DETAILED DESCRIPTION OF THE INVENTION

Suitable acetylenic compounds for use in the present invention are represented by the structure:

A-(CH₂)ₙ—C≡C—C≡C—(CH₂)ₘ—B:

wherein m and n are both independently an integer of from about 0 to 20 and A and B are independently methyl or carboxyl groups. Specific examples of such polyacetylenes include pentacosa-10,12-diynoic acid; 13,15-octacosadiyne and docosa-10,12-diyne-1, 22-dioic acid. Of these, pentacosa-10,12-diynoic acid is most preferred since it provides unusually high sensitivity to ionizing radiation exposure. It is to be understood however, that dispersions of other normally crystalline, color developing polyacetylenes having a conjugated structure can be employed alone or in admixture with the preferred diynes as the image receptive layers of the present invention. Such compounds include the diynes of the above structure wherein the A and/or B moieties, in addition to lower alkyl or carboxyl, can also be hydroxy, amido, lower alkyl substituted amido, an aliphatic or aromatic carboxylate ester group having up to 10 carbon atoms, a mono- or di-valent carboxylate metal salt group, halo, carbamyl, lower alkyl substituted carbamyl or tosyl, as well as the corresponding triyne and tetrayne products of the above polyacetylenes having from 20 to 60 carbon atoms and a conjugated structure. Examples of these compounds include 10,12-docosadiynediol, the ditoluene-p-sulfonate of 9,11-eicosadiynoic acid, the monoethyl ester of 10,12-docosadiynedioic acid, the sodium or potassium salt of 10,12-pentacosadiynoic acid, the zinc salt of heneicosa-10,12- diynoic acid, the manganese salt of eicosa-5,7-diynoic acid, 10,12-docosadiyne chloride, 10,12-pentacosadiyne (m-tolyl-urethane), 10,12-pentacosadiyne {[(butoxyl-carbonyl)-methyl]urethane}, N-(dimethyl)-10,12-pentacosadiynamide, N,N′-bis(α-methylbenzyl) 10,12-pentacosadiyndiamide and the like. In addition, the diacetylenes for use in accordance with the invention generally may also have the formula:

R—C≡C—C≡C—R′

wherein R and R′ are, for example, both CH₂—O—CON—H—(CH₂)₅CH₃. Such diacetylenes polymerize in the solid state either upon thermal annealing or exposure to high energy radiation. Suitable compounds are described in U.S. Pat. Nos. 5,420,000, 4,970,137, and 4,734,355, the contents of each of which are incorporated herein by reference. Preferably, the polyacetylenic compound has at least two conjugated acetylenic linkages and contains from about 10 to 60 carbon atoms.

Suitable compounds, which selectively absorb incident low energy photon radiation, are the metal halides and combinations thereof of Group I of the Periodic Table. These compounds may be added in amount effective to selectively absorb the incident low energy photon radiation, and generally in an amount of from about 0. 1% to 50.0%, and preferably 2.5% to 20% by weight of the dispersion of the coating as described hereinafter.

Most preferably, such halides are selected from the group consisting of cesium and rubidium halides and in particular, cesium chloride, cesium bromide, cesium iodide and combinations thereof.

In addition, it is possible to add an additional compound, which is a metal ion chelating agent or sequestering agent. The chelating agent can be added in amounts of from about 0.01% to 10.0%, and preferably 0.1% to 2% by weight, based on the weight of the diacetylene compound. Typical chelating agents include disodium ethylenediaminetetraacetate, sodium oxalate, citric acid, sodium citrate, sodium tartrate, sodium polyphosphate, potassium hypophosphate, sodium diethyldithiocarbamate, the sodium salt of N,N,N′,N′-ethylenediaminetetra(methylenephosphonic acid), the sodium salt of 1-hydroxyethane-1,1-diphosphonic acid and combinations thereof.

An opacifying agent may also be added to the inventive composition. Usually such an agent is a water insoluble metal compound wherein the metal component has an atomic number greater than 18. Examples of suitable compounds include oxides, carbonates, sulfates, sulfites, sulfides, carboxylates, phosphates, phosphates and silicates. An antioxidizing agent may also be added to the composition, usually in an amount of from about 0.01% to 5%, and preferably 0.1 to 1% by weight of the weight of the diacetylene component. Suitable antioxidizing agents include propyl gallate, Tenoxo 6 (Tenox® is a trademark of the Eastman Chemical Company), Tenox® 2, Tenox® 7, Tenox®20, sodium diethyldithiocarbamate, citric acid, sodium citrate, ascorbic acid, alkali metal sulfides and sulfites, 3-tert-butyl-4-hydroxy-5-methylphenyl sulfide, butylated hydroxytoluene, butylated hydroxyanisole, tert-butylhydroquinone, hydroxylamine and hydroxylamine hydrochloride

The acetylenic component may also be sandwiched between two films in which one or both of the films may have the capability to filter light in the UV and/or visible wavelength regions.

In preparing the inventive film, the polyacetylenic compound is dispersed in a non-solvating liquid and is ripened or aged to maximize its radiation sensitivity. This dispersion also contains a dissolved polymeric binder. Examples of binders include, but are not limited to, gelatin, agar, xanthan gum and polymers and copolymers containing maleic acid or acrylic acid residues, or salts thereof. The liquid dispersion is then applied onto the surface of a film, e.g., a polyester or similar film, and the coating is then dried. In particular, the normally crystalline polyacetylenic compound is dispersed into the non-solvating liquid in a concentration of from about 2 to 50% based on the combined weights of the polyacetylenic crystalline compound, the non-solvating liquid and the polymeric binder dissolved therein. The dispersion is then aged or ripened by either (a) storing the composition at a temperature of from about 0 degrees C. to about 12 deg. C for a period of from about 1 to 30 days, or (b) freezing the dispersion at a temperature between about −78 deg. C and about −1 deg. C for a period of time from about 1 to about 75 hours, or (c) a combination of both of the above techniques. This aging or ripening step is to be completed before drying the dispersion on the substrate.

In accordance with the present invention, after the aging or ripening of the dispersion, a compound which selectively absorbs incident low energy photon radiation is mixed therewith in an amount which is effective to absorb incident low energy photon radiation when the dried composition is exposed thereto.

The thus mixed composition is then applied as a layer onto a substrate or support layer which is a polymeric film which is permeable to low energy x-rays. The thus coated substrate is then dried at a temperature from about ambient up to about 100 deg. C but below the distortion temperature of the substrate and below the decomposition temperature of any of the components of the coating or the melting point of the polyacetylene compound therein. The drying operation is generally conducted over a period of from about 20 seconds to about 10 hours and is preferably effected at 15 deg. to 60 deg. C for a period of from about 1 minute to about 5 hours.

The film thus formed is sensitive to radiation and, upon irradiation, a polymerization process is initiated in the polyacetylenic compound resulting in an immediate change in the color of the coating. The color darkens in proportion to the radiation exposure. The degree of darkening may be measured with a number of instruments including densitometers, spectrophotometers and film scanners. Generally when making such measurements, the color change of a transparent film sample would be assessed by measuring the proportion of light transmitted through the sample. Similarly, film coated on an opaque film base would be appropriately examined by measuring the proportion of light reflected from the sample.

Since the film darkens in proportion to radiation exposure, it is possible to measure the darkening and use this measurement as a means for determining the amount of the radiation exposure. Thus, the film may be employed as a radiation dosimeter, to measure and map radiation fields. Alternatively, the film may be used to record visual images such as those produced by radiographs, or autoradiographs.

The following examples illustrate the invention.

### EXAMPLE 1

### Radiation Sensitive Dispersion

A microcrystalline dispersion of pentacosa-10, 12-diynoic acid in aqueous gelatin was made and ripened by procedures similar to those disclosed in U.S. Pat. Nos. 4,734,355 and 4,970,137.

### EXAMPLE 2

### Improved Sensitivitv to X-Rays Through the Use of High Atomic Number Additives

Sample A was made by coating the radiation sensitive dispersion of Example 1 on a polyester film base using a #55 wire-wound rod.

Sample B was made similar to Sample A except that 3 parts by weight of cesium chloride was added to the dispersion for every 10 parts by weight of solids contained in the dispersion.

Sample C was made similar to sample B except that cesium bromide was substituted for cesium chloride.

Sample D was made similar to sample B except that cesium iodide was substituted for cesium chloride.

The visual transmission densities of the coatings were measured on an X-Rite 310T densitometer. The coatings were then exposed to an approximately 15Gy dose of x-rays generated from a source operating at 150 kVp. The x-rays were filtered through 1 mm of aluminum. After the exposures the visual densities of the samples were again measured. Results are shown in Table I.

TABLE I

| | | | Density | Density | |
|---|---|---|---|---|---|
| | | | Before | After | Density |
| Sample # | Additive | Exposure, Gy | Exposure | Exposure | Change |
| A | None | 14.95 | 0.08 | 0.21 | 0.13 |
| B | CsCl | 14.97 | 0.09 | 1.23 | 1.14 |
| C | CsBr | 14.97 | 0.09 | 1.32 | 1.23 |
| D | CsI | 15.01 | 0.09 | 1.43 | 1.34 |

The data demonstrate that the use of cesium halide additives greatly increased the sensitivity of the coatings to x-ray exposure. Furthermore, the effectiveness of the additives increase in the order CsI>CsBr>CsCl. This is in the same order as the average atomic number of the additives.

### EXAMPLE 3

### Decreased Light Sensitivity and Decreased Dark Reaction Through the Use of Sequestering Agents as an Additive

Sample A was prepared by coating the dispersion of Example 1 on a clear polyester base with a #55 wire-wound rod. After the coating was dry, drops of aqueous solutions of metal ion chelating or sequestering agents were spread onto the coating and dried. These chelating agent additives included disodium ethylenediaminetetraacetate, sodium citrate, sodium polyphosphate, potassium hypophosphate, sodium diethyldithiocarbamate, the sodium salt of N,N,N′,N′-ethylenediaminetetra (methylenephosphonic acid) and the sodium salt of 1-hydroxyethane-1,1-diphosphonic acid. The concentration of the additive solutions was approximately 5×10⁻⁵M. Each drop was about 50 mg in weight and was spread out to cover about 1 cm² of the coating. An additional control test was performed by applying a drop of plain water to the coating. After drying, the sample was placed into a dark test chamber at 50C and 50% RH for 1 week. Upon observation of the sample at the end of the test period it was obvious that most of the coating had turned light blue. This is evidence that the photoactive component, pentacosa-10, 12-diynoic acid, had, to a degree, undergone polymerization during the test period even though not exposed to light or radiation. This phenomenon is referred to as dark reaction. However, where the coating had been spotted with the additive solutions, the coating was noticeably lighter in color indicating that the additives retard the dark reaction. Where the coating was spotted with plain water the treated area had substantially the same depth of color as the surrounding untreated coating. The most effective of the additives were disodium ethylenediaminetetracetate and sodium diethyldithiocarbamate.

Another sample was prepared and treated with the additive solutions as for Sample A. This sample then exposed to cool white fluorescent light of about 3000 lux intensity for 3 days. At the end of the test period the sample was observed. Where the coating had been treated with the additive solutions the sample was distinctly less blue, indicating that the additives had reduced the white-light sensitivity of the photoactive component. Where the coating was spotted with plain water the treated area had substantially the same depth of color as the surrounding untreated coating. The most effective of the additives was disodium ethylenediaminetetraacetate.

A further sample was prepared and treated with the additive solutions as for Sample A. This sample was then exposed to an absorbed dose about 25Gy of radiation from a Co⁶⁰ source. Upon observation of the sample after exposure it could be seen that the sample had turned a substantially uniform shade of blue. Where the coating was spotted with plain water the treated area had substantially the same depth of color as the surrounding untreated coating. This indicates that the additives have no significant effect on the sensitivity of the photoactive component to high energy photons.

A final sample was prepared and treated with the additive solutions as for Sample A. This sample was then exposed to an absorbed dose about 25Gy of x-rays from a source operating at 150 kVp. Upon observation of the sample after exposure it could be seen that the sample had turned a substantially uniform shade of blue. This indicates that the additives have no significant effect on the sensitivity of the photoactive component to low energy photons.

### EXAMPLE 4

### Decreased Light Sensitivity and Decreased Dark Reaction Through the Use of Propyl Gallate as an Additive

Sample A was made by coating the radiation sensitive dispersion of Example 1 on an opaque white polyester film base using a # 90 wire-wound rod.

Sample B was made similar to Sample A except that propyl gallate was added to the dispersion in a 1: 4000 weight-for-weight ratio.

Sample C was made similar to Sample B except that the ratio of propyl gallate to dispersion was changed to 1:2000.

Sample D was made similar to sample B except that the ratio of propyl gallate to dispersion was changed to 3:4000.

Sample E was made similar to Sample A except that cesium bromide was added to the dispersion in a 1:40 weight for weight ratio.

Sample F was made similar to Sample E except that propyl gallate was added to sample E in a 1:5000 weight-for-weight ratio.

Sample G was made similar to sample F except that the ratio of propyl gallate to dispersion was changed to 2:5000.

Sample H was made similar to sample F except that the ratio of propyl gallate to dispersion was changed to 3:5000.

The white light sensitivity of samples A to H was evaluated by measuring the change in visual optical density that occurred as a result of exposure to a cool white fluorescent light source of about 3000 lux intensity. The results are shown in Tables II and III.

TABLE II
White light sensitivity of dispersion

| | Propyl gallate | Density | Density (After | |
|---|---|---|---|---|
| Sample # | Additive ratio | (Before) | 15 days) | Density Change |
| A | None | 0.094 | 0.397 | 0.303 |
| B | 1:4000 | 0.103 | 0.345 | 0.242 |
| C | 1:2000 | 0.103 | 0.285 | 0.182 |
| D | 3:4000 | 0.100 | 0.290 | 0.190 |

TABLE III
White light sensitivity of dispersion containing cesium bromide

| | Propyl gallate | Density | Density (After | |
|---|---|---|---|---|
| Sample # | Additive ratio | (Before) | 28 days) | Density Change |
| E | None | 0.125 | 0.933 | 0.808 |
| F | 1:5000 | 0.111 | 0.426 | 0.315 |
| G | 2:5000 | 0.134 | 0.412 | 0.278 |
| H | 3:5000 | 0.113 | 0.390 | 0.277 |

Dark Reaction of Dispersion Containing Cesium Bromide

The dark reaction of samples E to H was evaluated by measuring the change in visual optical density that occurred after conditioning the samples at 50° C. and 50%RH for 21 days. The results are shown in Table IV.

TABLE IV

| | Propyl gallate | Density | Density (After | |
|---|---|---|---|---|
| Sample # | Additive ratio | (Before) | 21 days) | Density Change |
| E | None | 0.121 | 0.217 | 0.096 |
| F | 1:5000 | 0.115 | 0.161 | 0.046 |
| G | 2:5000 | 0.100 | 0.124 | 0.024 |
| H | 3:5000 | 0.104 | 0.140 | 0.036 |

The data demonstrate that the use of propyl gallate additive greatly decreased the white light sensitivity of the coatings and the dark reaction of coatings.

### EXAMPLE 5

### Decreased Light Sensitivitv and Decreased Dark Reaction Through the Use of Tenoxe 6 as an Additive

Sample A was made similar to Sample E of Example 4.

Sample B was made similar to Sample A except that Tenox® 6 was added to the dispersion in a 1:5000 weight-for-weight ratio.

Sample C was made similar to Sample B except that the ratio of Tenox® 6 to dispersion was changed to 2:5000.

Sample D was made similar to sample B except that the ratio of Tenox® 6 to dispersion was changed to 3:5000. The visual reflection densities of the coatings were measured using the reflectance attachment to an X-Rite 310T densitometer. The coatings were then put on a light table with the coating side down. After 28 days the visual densities of the samples were again measured. Coatings were also put into a dark 40° C. oven for 21 days. The visual densities were re-measured at the end of the test period. Results are shown in Tables V and VI

TABLE V
White light sensitivity of dispersion containing cesium bromide

| | | Density | Density (After | |
|---|---|---|---|---|
| Sample # | Additive Ratio | (Before) | 28 days) | Density Change |
| E | None | 0.095 | 0.826 | 0.731 |
| F | 1:5000 | 0.099 | 0.501 | 0.402 |
| G | 2:5000 | 0.098 | 0.396 | 0.298 |
| H | 3:5000 | 0.093 | 0.373 | 0.280 |

TABLE VI
Dark reaction of dispersion containing cesium bromide

| | | Density | Density (After | |
|---|---|---|---|---|
| Sample # | Additive Ratio | (Before) | 21 days) | Density Change |
| E | None | 0.093 | 0.128 | 0.035 |
| F | 1:5000 | 0.098 | 0.121 | 0.023 |
| G | 2:5000 | 0.098 | 0.121 | 0.023 |
| H | 3:5000 | 0.093 | 0.114 | 0.021 |

The data demonstrate that the use of additive, Tenox® 6 greatly decreased both white light sensitivity and dark reaction of the coatings.

### EXAMPLE 6

### Lamination of Coated Film Without an Adhesive

A coating fluid was prepared containing 45.2 kg of the dispersion of Example 1 to which had been added 1.2 kg of cesium bromide, 0.28 kg of an 8% aqueous solution of disodium ethylenediaminetetraacetate, 0.45 kg of a 2% aqueous solution of propyl gallate and 0.45 kg of a 10% aqueous solution of the surfactant OLIN 10G. A coating was made by applying this fluid to a corona treated clear polyester film base. The film was dried to form a coated layer of about 10 microns in thickness.

Two rolls of the coated film were set up on a laminator. The coated sides of the films were in contact as the films passed into the nip between laminating rollers. The laminating rollers and the nip were horizontal. The laminator was run at a speed of 25 ft/min. Into the area between the films entering the nip was dripped a fluid composed of equal weights of water and methanol. The rate of flow of this fluid was such as to completely wet the surfaces of the films at the nip. The laminated film product was wound up as a roll. It was found that the product was firmly and completely laminated to form a structure containing a photoactive layer about 20 microns in thickness sandwiched between clear polyester bases.

If the photoactive layer on the original, un-laminated coating was wet with water, the layer quickly becomes cloudy and opaque. However the laminated coating was still perfectly clear indicating that only small amounts of water had been retained. Through gravimetric analysis it was shown that the amount of laminating fluid retained in the laminate was about 150 mg/ft².

### EXAMPLE 7

### Increased X-Ray Sensitivity of Laminated Film Through the Use of White Polyester Base Containing Baryta as an Opacifying Agent.

A coating similar to Sample C of Example 2 was prepared on clear polyester film base. A second similar coating was made on DuPont 339 polyester film base. This latter base is an opaque, white film containing baryta as an opacifying agent. These film samples were exposed to about a 15Gy dose of x-rays generated from a source operating at 150 kVp. The x-rays were filtered through 1 mm of aluminum. The coatings were then stripped away from the polyester bases and the visual transmission densities of the coatings were measured with an X-Rite 310T densitometer. Similarly, the unexposed coatings were stripped from their bases and measured with the densitometer. The net density change after exposure was 1.27 for the sample coated on the clear polyester and 1.36 for the sample coated on the opaque, white, baryta filled polyester base. Baryta contains the high atomic number element barium. The result demonstrates that the x-ray sensitivity of a coating containing the high atomic number additive cesium bromide is further increased through the use of a polyester substrate filled with a high atomic number additive.

### EXAMPLE 8

### Improved Optical Absorption Through the Use of an Opaque, White Polyester Base as Opposed to a Clear Polyester Base.

A coating similar to Sample A of Example 2 was prepared on clear polyester film base. A second similar coating was made on the DuPont 339 opaque, white polyester film base. The visual densities of the coatings were measured on an X-Rite 310T densitometer. For the sample on clear polyester base the transmission density was measured. The sample on the DuPont 339 base was measured using the reflectance attachment to the densitometer. The samples were then exposed to like amount of short-wave UV radiation after which they were re-measured. The results are shown in Table VII

TABLE VII

| | Density Before | Density After | |
|---|---|---|---|
| Film Base | Exposure | Exposure | Density Change |
| Clear polyester | 0.08 | 0.73 | 0.64 |
| Opaque, white | 0.10 | 1.19 | 1.09 |
| polyester | | | |

This example demonstrates that the visual density of an exposed coating on opaque, white polyester base is substantially greater than a similar exposed sample coated on clear polyester base. The difference is principally due to the fact that on the clear base, light, in transmission, passes through the coating a single time, whereas on the opaque base, light, in reflection, passes through the coating once before it is reflected, or scattered back from the substrate and passes again through the coating. Since the total light absorption is proportional to the path length through the coating, a coating of a given thickness with a given concentration of absorber on a reflective film base will have a greater optical density than a similar coating on a transmissive film base.

### EXAMPLE 9

### Decreased Light Sensitivity Through the Use of Yellow Base

Sample A and Sample B were made by coating the radiation sensitive dispersion of Example 1 on a polyester film base using a # 90 wire-wound rod.

The visual transmission densities of the two coatings were measured on an X-Rite 310T densitometer. A yellow, transparent, polyester filter (CIE color coordinates L*=77.84, a*=29.66 and b*=124.33) and a colorless, transparent polyester filter were then put on top of the coated side of Sample A and Sample B respectively. The coatings were then put on a light table with the yellow base side down for Sample A and clear base side down for Sample B. The light table was illuminated with cool white fluorescent light bulbs. The light intensity at the location of Sample A was 63% of the intensity at the location of Sample B. The visual densities of Samples A and B were again measured after 14 days exposure on the light table. Results are shown in Table VIII

TABLE VIII
White light sensitivity

| | | | | | |
|---|---|---|---|---|---|
| | | Light | Density | Density After | Density |
| Sample | Filter | Intensity | Before | 14 days | Change |

| | | | | | |
|---|---|---|---|---|---|
| A | Yellow | 63 | 0.094 | 0.101 | 0.007 |
| B | Colorless | 100 | 0.093 | 0.166 | 0.073 |

After compensation for the lesser intensity of light at the location of Sample A, the data show that the density change of Sample A over the test period was only about 15% of the density change for Sample B. This demonstrates that the use of a yellow filter greatly decreased the sensitivity of the coating to white light exposure.

### EXAMPLE 10

### Energy Independence of Coated Film

A sheet of laminated film was prepared similar to Example 6 except that yellow polyester film base (CIE color coordinates L*=77.84, a*=29.66 and b*=124.33) was used instead of clear polyester film base. Samples A, B, C and D were cut from the sheet and the size of each sample was 3″×0.5″.

Sample A was cut into six smaller samples. These six smaller samples were separately exposed to doses of 0.25 Gy, 0.85 Gy, 2.85 Gy, 6 Gy, 9.5 Gy, and 32 Gy with 120 kVp X-rays filtered through 2 mm of aluminum.

Sample B was cut into six smaller samples. These six smaller samples were separately exposed to doses of 0.25 Gy, 0.85 Gy, 2.85 Gy, 6 Gy, 9.5 Gy, and 32 Gy with 100 kVp X-rays filtered through 2 mm of aluminum.

Sample C was cut into six smaller samples. These six smaller samples were separately exposed to doses of 0.25 Gy, 0.85 Gy, 2.85 Gy, 6 Gy, 9.5 Gy, and 32 Gy with 80 kVp X-rays filtered through 2 mm of aluminum.

Sample D was cut into six smaller samples. These six smaller samples were exposed to doses of 0.25 Gy, 0.85 Gy, 2.85 Gy, 6 Gy, 9.5 Gy, and 32 Gy with 60 kVp X- rays filtered through 2 mm of aluminum.

The Status A red transmission densities of the samples were measured using an X-Rite 310T densitometer before and after exposure. Results are shown in Table IX

TABLE IX

| Sample # | 0.25 Gy | 0.85 Gy | 2.85 Gy | 6 Gy | 9.5 Gy | 32 Gy |
|---|---|---|---|---|---|---|
| A | 0.067 | 0.208 | 0.594 | 1.070 | 1.613 | 2.645 |
| B | 0.066 | 0.208 | 0.581 | 1.086 | 1.544 | 2.666 |
| C | 0.064 | 0.196 | 0.560 | 1.066 | 1.532 | 2.689 |
| D | 0.057 | 0.180 | 0.537 | 0.968 | 1.426 | 2.672 |

The data demonstrate that the media is energy independent in the energy range of 80 kVp-120 kVp. The response to 60 kVp x-rays is about 5% lower than the response to 80 kVp-120 kVp x-rays. Furthermore, the results clearly demonstrate that the transmission densities of the samples increase in proportion to exposure.

### EXAMPLE 11

### Stability of Laminated Yellow Film

Samples A, B, C, D, E were made similar to Example 10. The Status A red transmission densities of the coatings were measured using an X-Rite 31 OT densitometer.

Sample A was then put on a light table. The table was illuminated with cool white fluorescent light at an intensity of about 3000 lux. The transmission densities of the samples were re-measured after 1, 7, 16, 26, 40, and 70 days.

Sample B, C, D, and E were separately placed into black envelopes and stored in a 40° C. oven, a 50° C. oven, and a refrigerator and at room temperature respectively. The transmission densities of the samples were re-measured after 1, 26, 40, and 70 days. The results are shown in Table X.

TABLE X

| Light | Sample A | Sample B | Sample C | Sample D | Sample |
|---|---|---|---|---|---|
| exposure | 40° C. | 50° C. | Refrigerator | Room temp. | E |
| 0 day | 0.073 | 0.074 | 0.074 | 0.073 | 0.072 |
| 1 day | 0.075 | 0.075 | 0.058 | 0.075 | 0.074 |
| 7 day | 0.081 | — | — | — | — |
| 16 days | 0.093 | — | — | — | — |
| 26 days | 0.095 | 0.088 | 0.054 | 0.075 | 0.079 |
| 40 days | 0.102 | 0.088 | 0.054 | 0.074 | 0.077 |
| 70 days | 0.114 | 0.074 | 0.074 | 0.073 | 0.072 |

The results for Samples B to E demonstrate that the film is exceptionally stable under storage in the dark, even at temperatures of 40C and 50C. This means that the shelf life of film has no strong dependence on storage temperature and indicates that the film could be stored for long periods of time without significant change. In addition the behavior of Sample A shows that the film also has a very low sensitivity towards light, making it convenient to handle in the normal office or laboratory environment.

### EXAMPLE 12

### Stability of Laminated Yellow Opaque film

Samples A, B, C, D, E were made in a similar manner to those in Example 10 except that on one side of the laminate a translucent white polyester base was exchanged for the yellow transparent polyester film base. The Status A red reflection densities of the coatings were measured using an X-Rite 310T densitometer.

Sample A was put on a light table with the yellow side down. Sample B was placed on the light table with the white side down. The light table was illuminated with cool white fluorescent light of about 3100 lux intensity. The samples were re-measured after 1, 7, 15, 26, 40, and 70 days.

Samples C, D, E and F were separately placed into black envelopes and stored in a 40° C. oven, a 50° C. oven, and a refrigerator and at room temperature respectively. The samples were re-measured after 1, 26, 43, and 70 days. The results are shown in Tables XI and XII.

TABLE XI
White Light Sensitivity of Laminated Yellow Opaque Film

| | Sample A | Sample B |
|---|---|---|
| 0 day | 0.155 | 0.158 |
| 1 day | 0.160 | 0.164 |
| 7 day | 0.174 | 0.180 |
| 15 days | 0.222 | 0.247 |
| 26 days | 0.228 | 0.261 |
| 40 days | 0.256 | 0.305 |
| 70 days | 0.318 | 0.402 |

TABLE XII
Dark Reaction of Laminated Yellow Opaque Film

| | Sample C | Sample D | Sample E | Sample F |
|---|---|---|---|---|
| 0 day | 0.154 | 0.154 | 0.153 | 0.155 |
| 1 day | 0.157 | 0.148 | 0.157 | 0.156 |
| 26 days | 0.154 | 0.124 | 0.127 | 0.134 |
| 43 days | 0.185 | 0.150 | 0.148 | 0.159 |
| 70 days | 0.154 | 0.154 | 0.153 | 0.155 |

The results for Samples C to F demonstrate that the film is exceptionally stable under storage in the dark, even at temperatures of 40C and 50C. This means that the shelf life of film has no strong dependence on storage temperature and indicates that the film could be stored for long periods of time without significant change. In addition the behavior of Samples A and B shows that the film also has a low sensitivity towards light. Since the intensity of the illumination in offices and laboratories is typically <1000 lux, one third of intensity to which the Samples A and B were exposed, the data show that the film can be handled for many days in these environments without significant fogging. This makes the film convenient to handle in the normal office or laboratory environment.

We claim:

1. A film media sensitive to low energy x-rays comprising a first support layer of polymeric film which is permeable to low energy x-rays and a second layer thereon of a composition comprising a microcrystalline dispersion of a substantially crystalline image receptive polyacetylenic compound and a compound that selectively absorbs incident low energy photon radiation.

2. The film media of claim 1 wherein the polyacetylenic compound has the structure:
A-(CH₂)ₙ—C≡C—C≡C—(CH₂)ₘ—B:
wherein m and n are both independently an integer from 6 to 14 and A and B are independent from one another and are selected from the group consisting of methyl, carboxyl, hydroxy, amido, lower alkyl substituted amido, aliphatic or aromatic carboxylate ester group having up to 10 carbon atoms, mono- or di-valent carboxylate metal salt group, halo, carbamyl, lower alkyl substituted carbamyl or tosyl, triyn or tetrayne products of the above polyacetylenes having from 20 to 60 carbon atoms and a conjugated structure, and combinations thereof.

3. The film media of claim 1 wherein the polyacetylenic compound is selected from the group consisting of pentacosa-10,12-diynoic acid; tricosa-10,12-diynoic acid, heneicosa-10,12-diynoic acid and combinations thereof.

4. The film media of claim 1 wherein the compound which selectively absorbs incident low energy photon radiation is present in an amount from about 0.1 to 50.0% by weight of the micro-crystalline dispersion.

5. The film media of claim 1 wherein the compound which selectively absorbs incident low energy photon radiation is selected from the group consisting of metal halides of Group I of the periodic table.

6. The film media of claim 5 wherein the halide is selected from the group consisting of cesium halides and rubidium halides.

7. The film media of claim 1 which further comprises a chelating agent.

8. The film media of claim 1 which further comprises a chelating agent present in an amount of from about 0.01 to 10.0% by weight based on the weight of the diacetylene compound.

9. The film media of claim 8 wherein the chelating agent is selected from the group consisting of:
disodium ethylenediaminetetraacetate, sodium citrate, sodium polyphosphate, sodium diethyldithiocarbamate, the sodium salt of N,N,N′,N′-ethylenediaminetetra(methylenephosphonic acid), the sodium salt of 1-hydroxyethane-1,1-diphosphonic acid and combinations thereof.

10. The film media of claim 1 which further comprises an opacifying agent.

11. The film media of claim 10 wherein the opacifying agent is selected from the group consisting of water insoluble metal compounds wherein the metal component has an atomic number greater than 18.

12. The film media of claim 11 wherein the opacifying agent is selected from the group consisting of oxides, carbonates, sulfates, sulfites, sulfides, carboxylates, phosphates, phosphites, and silicates and combinations thereof.

13. The film media of claim 1 which further comprises an anti-oxidizing agent present in an amount from about 0.01 to 5% by weight based on the weight of the diacetylenic component.

14. The film media of claim 13 wherein the oxidizing agent is selected from the group consisting of propyl gallate, Tenox®, Tenox® 2, Tenox® 7, Tenox® 20, sodium diethyldithiocarbamate, citric acid, sodium citrate, ascorbic acid, alkali metal sulfides and sulfites, 3-tert-butyl-4-hydroxy-5-methylphenyl sulfide, butylated hydroxytolurene, butylated hydroxyanisole, tert-butylhydroquinone, hydroxylamine, hydroxylamine hydrochloride, and combinations thereof.

15. The film media of claim 1 which further comprises a third layer of a polymeric film, wherein the second dispersion layer is sandwiched between the first and third layers and at least one of the polymeric film layers has the capability of filtering light in the ultraviolet or visible wavelength regions.

16. A method for preparing the film media of claim 1 comprising dispersing the polyacetylenic compound in a non-solvating liquid, aging the dispersion under conditions to maximize the compounds radiation sensitivity, and applying a coating of the aged dispersion onto a surface of the film, and subjecting the coated film to drying conditions.

17. In a method for determining the extent and distribution of exposure of a subject exposed to radiation wherein a dosimeter is used to measure the exposure of the subject, the improvement wherein the dosimeter comprises the film media of claim 1.

18. The method of claim 17 wherein the radiation is low energy x-rays from about 20 keV to 120 keV
